(19) United States
(12) Patent Application Publication
(10) Pub. No.: US 2006/0290334 A1
(43) Pub. Date: Dec. 28, 2006

(54) Duty cycle mode switching voltage regulator

(75) Inventor: Mel Bazes, Haifa (IL)

Correspondence Address: JUNG-HUA KUO;C/O PORTFOLIOIP, P. O. BOX 52050, MINNEAPOLIS, MN, 55402, US

(73) Assignee: Intel Corporation, A DELAWARE CORPORATION, Santa Clara, CA (US)

(21) Appl. No.: 11/168,114

(22) Filed: Jun. 28, 2005

(51) Int. Cl. G05F 1/00

(52) U.S. Cl. 323/282

(57) ABSTRACT

One disclosed method includes controlling an output voltage to track a reference voltage by using a feedback loop to monitor an output duty cycle and to maintain an output voltage that is substantially constant relative to the reference voltage.

### BACKGROUND

Integrated circuit chips such as microprocessors often make use of different supply voltages for different parts of the chip. A main supply voltage may be provided to the chip from an off-chip source, and one or more voltage regulators may be used to convert the main supply voltage into the other, typically lower, supply voltages that are used by the chip. When the main supply voltage is the highest of the supply voltages used by the chip, the voltage regulators that are used to obtain the other, lower voltages are sometimes referred to as “buck” voltage regulators. Lower operating voltages can help reduce power consumption, and can enable the design of denser and faster circuits. Switching voltage regulators are often used when it is desirable to convert one voltage to another voltage with relatively high efficiency, thereby reducing heat generation and further reducing power consumption.

### BRIEF DESCRIPTION OF THE DRAWINGS

Reference will be made to the following drawings, in which:

FIG. 1 is an illustration of an embodiment of a voltage regulator.

FIG. 2 illustrates an output waveform associated with a voltage regulator such as that shown in FIG. 1.

FIG. 3 is an illustration of another embodiment of a voltage regulator.

FIG. 4 shows various waveforms associated with the operation of a voltage regulator such as that shown in FIG. 3.

FIG. 5 is an illustration of an embodiment of a pulse generator for use with a voltage regulator such as that shown in FIG. 3.

FIG. 6 is an illustrative state transition diagram for the pulse generator shown in FIG. 5.

FIG. 7 shows an illustrative method of using a voltage regulator such as that shown in FIG. 1 or FIG. 3.

FIG. 8 is an illustration of a circuit that makes use of one or more voltage regulators such as those shown in FIGS. 1 and 3.

### DESCRIPTION OF SPECIFIC EMBODIMENTS

Systems and methods are disclosed for performing voltage regulation. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

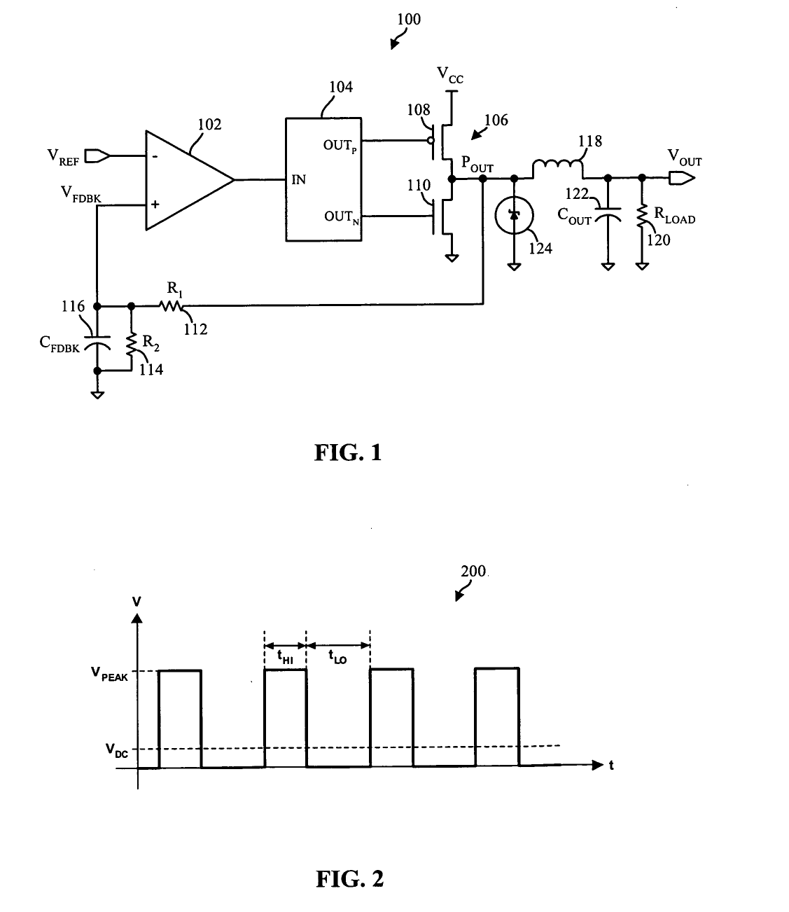

FIG. 1 shows an exemplary embodiment of a switching voltage regulator 100 for converting an input supply voltage, V_{CC}, to a lower output supply voltage, V_{OUT}, with relatively high efficiency. For example, in one embodiment a voltage regulator such as that shown in FIG. 1 could be used to convert a 3.3 volt supply voltage to 1.8 volts, although in other embodiments other voltages could be used. Referring to FIG. 1, a comparator 102, such as a differential amplifer, accepts a precision reference voltage, V_{REF}, and a feedback voltage, V_{FDBK}, and provides an output voltage that represents the amplified difference between the two inputs. The output of comparator 102 is coupled as an input to pre-driver circuit 104, the output of which is used to drive an inverting output stage 106 comprising two field effect transistors (FETs) 108, 110. In the embodiment shown in FIG. 1, transistors 108 and 110 are complementary metal oxide semiconductor (CMOS) transistors, namely, a p-type metal oxide semiconductor (PMOS) transistor 108 and an n-type metal oxide semiconductor (NMOS) transistor 110. Output stage 106 produces a pulsed output voltage, P_{OUT}, that has the form of a pulse train such as that shown in FIG. 2. As shown in FIG. 1, the pulsed output voltage, P_{OUT}, is fed back to the positive input of comparator 102 via the voltage divider comprised of resistors R₁ 112 and R₂ 114.

The above-described portion of switching voltage regulator 100 thus has the form of a negative-feedback loop, where the direct current (DC) value of P_{OUT}, after division by the voltage divider comprising resistors R₁ 112 and R₂ 114, is forced to equal V_{REF}. The DC value of P_{OUT} is obtained by low-pass-filtering the output of the voltage divider with capacitor C_{FDBK} 116 to produce voltage V_{FDBK}. This feedback loop has a large phase-shift that includes contributions from the low-pass filter and from the various other components of the loop (e.g., the delays of gates, etc.). In one embodiment, this phase-shift may be intentionally (e.g., through simulation) made larger than 180° so that the loop is unstable and oscillates. As a result, P_{OUT} has the form of a pulse train that can be characterized by its frequency and duty cycle.

It will be appreciated that the oscillation frequency of P_{OUT} can be readily adjusted using simulations or in any other suitable manner. For example, in some embodiments it may be desirable to adjust the frequency of P_{OUT} such that it is high enough to minimize output ripple, but low enough to keep power loss, which typically increases with oscillation frequency, at an acceptable level for the particular application. For example, in one embodiment the frequency of P_{OUT} is set between five hundred kilohertz and one megahertz, although it will be appreciated that in other embodiments other frequencies could be used.

FIG. 2 shows an example of the basic P_{OUT} waveform 200 under steady-state conditions. Applying a low-pass filter to P_{OUT} removes the alternating current (AC) components and passes the direct current (DC) component (V_{DC} in FIG. 2). The DC component is given by:

$${V}_{DC} = {V}_{PEAK} \cdot ( \frac{{t}_{HI}}{{t}_{LO} + {t}_{HI}} ) = {V}_{PEAK} \cdot DUTY\_CYCLE \qquad Equation 1$$

where V_{PEAK} is the peak voltage of the P_{OUT} voltage waveform, and the duty cycle is the time that P_{OUT} is at a high value divided by the period of the POUT waveform (i.e., t_{HI}/(t_{HI}+t_{LO})). Thus, V_{DC} is essentially the average value of the P_{OUT} voltage waveform.

It should be appreciated that while Equation 1, and the other equations that follow, refer to the equality of various quantities, the relationships described in these equations are, to some degree, approximations, since certain, typically insubstantial factors have been ignored (e.g., the non-zero rise time of P_{OUT} in FIG. 2, the series resistance of the wires that couple various elements in FIG. 1, and the like). Thus, use of the equals symbol (i.e., “=”) refers to substantial equality, and should not be interpreted to require exact equality of the quantities referenced in the equations.

Referring once again to FIGS. 1 and 2, V_{PEAK} is given by:

$${V}_{PEAK} = {V}_{CC} \cdot ( \frac{{R}_{OUT}}{{R}_{S} + {R}_{OUT}} ) \qquad Equation 2$$

where R_{OUT} is the effective DC resistance of all the circuitry driven by P_{OUT}, including the effective series resistance of filter (e.g., inductor) 118 and load resistance, R_{LOAD}, 120, and where R_{S} is the effective series resistance of the PMOS transistor 108 in the CMOS transistor pair driving P_{OUT}. In order to achieve high efficiency, R_{S} is preferably much less than R_{OUT}, so that the delivered power is mainly dissipated in R_{OUT} and not in R_{S}.

Substituting Equation 2 into Equation 1, yields:

$${V}_{DC} = {V}_{CC} \cdot DUTY\_CYLCE \cdot ( \frac{{R}_{OUT}}{{R}_{S} + {R}_{OUT}} ) \qquad Equation 3$$

V_{DC}, after division by the voltage divider comprising resistors R₁ 112 and R₂ 114, is fed back to comparator 102 as V_{FDBK}. Through negative feedback, V_{FDBK} is forced to effectively equal V_{REF}, the input reference voltage. Thus, V_{DC} is also given by:

$${V}_{DC} = ( 1 + \frac{{R}_{1}}{{R}_{2}} ) \cdot {V}_{REF} \qquad Equation 4$$

Referring once again to FIG. 1, the components to the right of P_{OUT} are connected in a fashion similar to that used in conventional switching voltage regulators. The combination of filter 118 and capacitor 122 effectively removes the AC components from P_{OUT}, and leaves the DC component, which is V_{DC}.

The voltage appearing across the load resistor 120 is given by:

$${V}_{OUT} = {V}_{DC} \cdot ( \frac{{R}_{LOAD}}{{R}_{OUT}} ) \qquad Equation 5$$

Substituting Equation 4 into Equation 5 yields:

$${V}_{OUT} = {V}_{REF} \cdot ( 1 + \frac{{R}_{1}}{{R}_{2}} ) \cdot ( \frac{{R}_{LOAD}}{{R}_{OUT}} ) \qquad Equation 6$$

In general, the effective series resistance of filter 118 will be much smaller than R_{LOAD}, such that R_{LOAD}≈R_{OUT}. Thus, to a relatively high degree of accuracy:

$${V}_{OPUT} ≅ {V}_{REF} \cdot ( 1 + \frac{{R}_{1}}{{R}_{2}} ) \qquad Equation 7$$

Voltage regulator 100 is thus able to control the output voltage with a high degree of accuracy by examining the pulsed output on P_{OUT}, even without directly examining the voltage on the load, V_{OUT}. Moreover, by taking its feedback from the input of filter 118 instead of from the filter's output, voltage regulator 100 avoids the problems caused by having two imaginary poles created by filter 118 and capacitor 122 in the feedback loop: with the feedback taken before the filter 118, these imaginary poles are outside of the loop and do not affect the loop response.

Thus, in contrast to conventional current-mode and voltage-mode switching voltage regulators, the voltage regulator 100 shown in FIG. 1 directly monitors neither output voltage nor output current, but, rather, monitors output duty cycle. For this reason, voltage regulator 100 will sometimes be referred to as a duty cycle mode switching voltage regulator (DCMSVR). The voltage regulator's feedback loop automatically controls the amount of time that the pulsed output, P_{OUT}, is high relative to the amount of time that it is low, such that the DC value of the pulsed output is a substantially constant function of V_{REF}.

Since the duty cycle is affected very little by changes in output voltage and output current, voltage regulator 100 outputs a nearly constant voltage irrespective of load. As a result, the danger of output current run-away is reduced. Although, during power-up, while the low-pass filter's output is building up, output current could potentially rise to large values, by ramping up V_{REF} slowly, this current rise can be limited to acceptable values.

In the embodiment shown in FIG. 1, a Schottky diode 124 prevents P_{OUT} from undershooting to large negative voltages during the time that the CMOS output stage 106 that generates P_{OUT} is switching. During switching, a small amount of dead time exists between the time PMOS transistor 108 turns off and the time NMOS transistor 110 turns on, and vice versa, in order to prevent current from rushing from V_{CC} to the circuit's common reference potential (i.e., ground) through the PMOS and NMOS transistors. During this dead time, the current in filter 118 pulls P_{OUT} to a negative value, which could turn on the normally back-biased source/drain diffusion diodes inside a chip to which the voltage regulator is connected, and generate large current pulses that could interfere with the chip's operation. Schottky diode 124, with its low forward conduction voltage, clamps the output voltage to a negative voltage that is less negative than that necessary to turn on the source/drain diodes, and thereby prevents the generation of large current pulses during the dead time during which transistors 108 and 110 are switching.

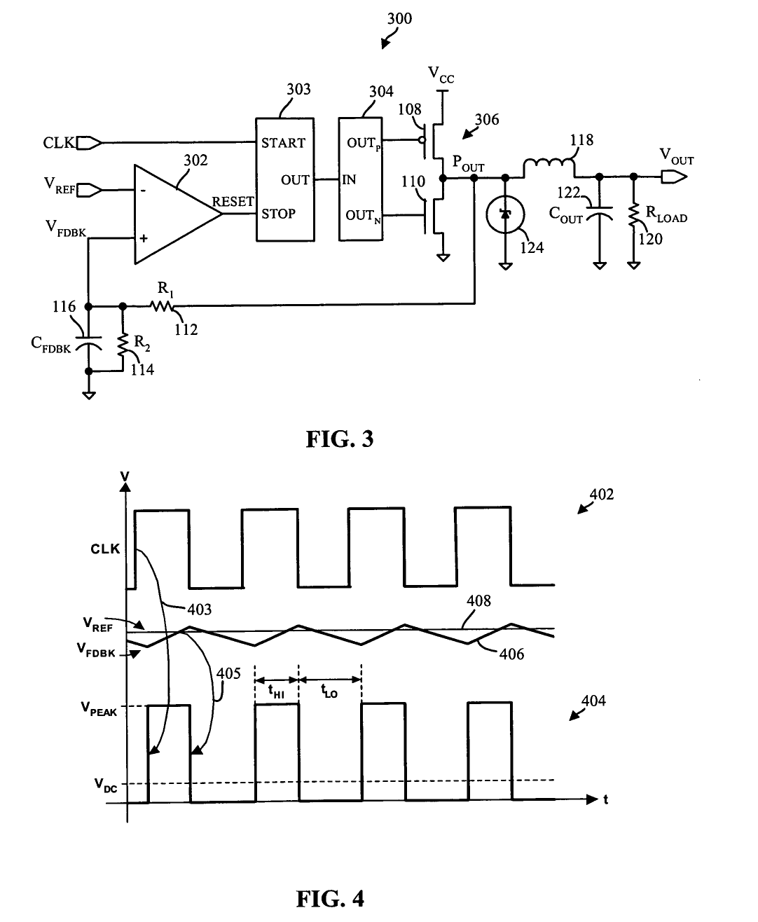

FIG. 3 is an illustration of another embodiment of a voltage regulator 300. Voltage regulator 300 is similar to voltage regulator 100 in FIG. 1, except in the embodiment shown in FIG. 3, voltage regulator 300's oscillation frequency is set using a pulse generator 303 that is driven by an external clock generator, oscillator, or similar device.

Pulse generator 303 outputs a pulse that starts on the rising edge of the clock input signal and ends when the output of comparator 302 goes high. Thus, the frequency of pulse generator 303 and, hence, of voltage regulator 300, is set by the frequency of the clock input.

In contrast, in the embodiment shown in FIG. 1, the oscillation frequency of P_{OUT} is set by delays in the feedback loop between P_{OUT} and the positive input, V_{FDBK}, of comparator 102. Since these delays can be variable and relatively difficult to set accurately, the voltage regulator's oscillation frequency can be relatively more difficult to set with precision.

In the embodiment shown in FIG. 3, the oscillation frequency is set by the clock input signal, thus enabling the oscillation frequency to be set as desired, and in a manner that is relatively insensitive to the voltage regulator's loop characteristics. Only the duty cycle of the voltage regulator's pulsed output is a function of the loop, and it is automatically set by the loop to provide the desired DC output voltage. Thus, as with the embodiment shown in FIG. 1, the feedback loop controls the amount of time that the pulsed output, P_{OUT}, is high relative to the amount of time that it is low, such that the DC value of the pulsed output is a substantially constant function of V_{REF}. However, unlike the embodiment shown in FIG. 1, the embodiment shown in FIG. 3 enables precise control of the output oscillation frequency, which is important since if the oscillation frequency is too high, efficiency tends to go down, while if the oscillation frequency is too low, the quality of the output signal tends to be poor.

FIG. 4 illustrates several waveforms associated with the voltage regulator 300 shown in FIG. 3. The clock (CLK) signal 402 sets the oscillation frequency of pulse generator 303's pulsed output 404. As shown at arrow 403 in FIG. 4, the rising edge of clock 402 starts a pulse in the pulse generator's pulsed output waveform 404, while, as shown at arrow 405, the comparator's output level ends the pulse (e.g., when V_{FDBK} 406 exceeds V_{REF} 408 and causes the RESET output from comparator 302 to go high). Thus, the frequency of the pulse generator's pulsed output waveform 404 is controlled by clock signal 402, and the duty cycle of the pulse generator's output waveform 404, and thus P_{OUT}, is controlled by the voltage regulator's feedback loop.

It should be appreciated that FIG. 4 is provided for purposes of illustration, and not limitation, and that a number of changes could be made without departing from the principles shown therein. For example, although the duty cycle of clock signal 402 is 50% in FIG. 4, it should be appreciated that this duty cycle may take on any suitable value that is compatible with circuit timing requirements, from very high to very low. It should also be appreciated that the waveforms shown in FIG. 4 are provided to illustrate relative timing characteristics, and are not drawn to scale. For example, in some embodiments V_{FDBK} 406 may vary by only a few millivolts or tens of millivolts around V_{REF} 408.

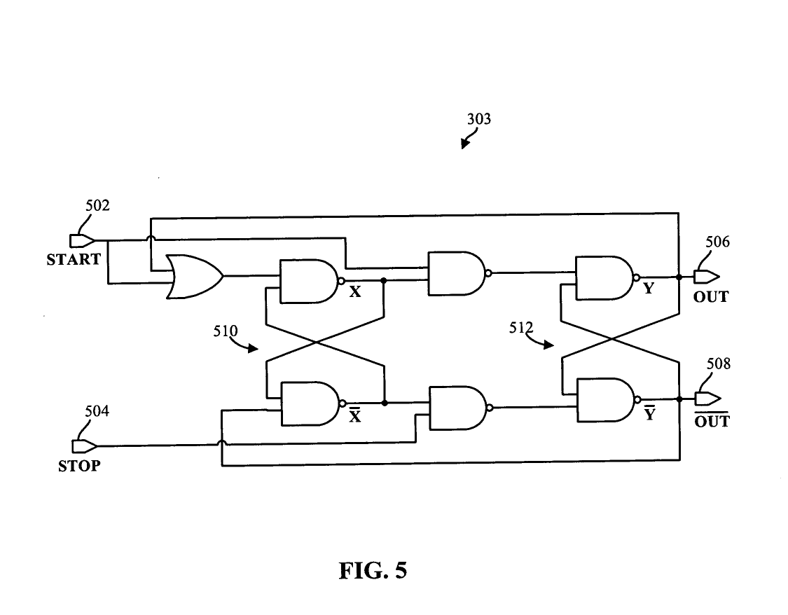

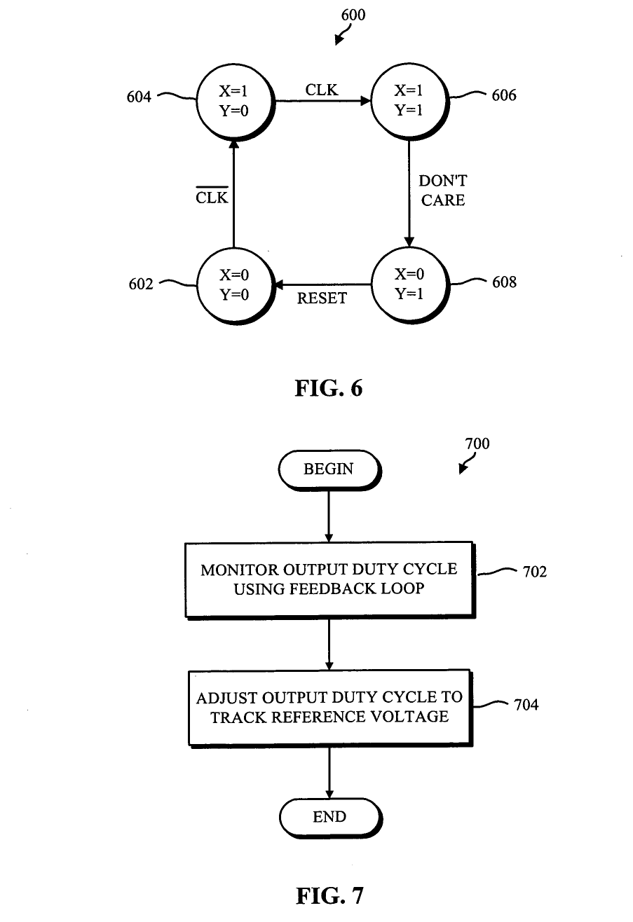

In one embodiment, pulse generator 303 may be implemented as an asynchronous finite-state machine (AFSM). FIG. 5 illustrates one possible implementation of pulse generator 303, and FIG. 6 illustrates its state-transition diagram 600.

Referring to FIG. 5, pulse generator 303 accepts a START input 502 and a STOP input 504, and provides an OUT signal 506 and its complement 508, comprising pulse generator 303's pulsed output. Two pairs of cross-coupled NAND gates 510, 512 provide state variables X and Y, which change as a function of inputs 502 and 504, as explained in more detail below in connection with FIG. 6. As shown in FIG. 3, the START input 502 of pulse generator 303 is coupled to an external clock signal (CLK), while the STOP input 504 is coupled to the output of comparator 302. The pulse generator's output, OUT 506, is coupled to the input of pre-driver 304, which, in one embodiment, is operable to invert the pulse generator's output signal before passing the output signal on to output stage 306. In other embodiments, the pulse generator's complementary OUT signal 508 is coupled to pre-driver 304.

It should be appreciated that FIG. 5 is provided for purposes of illustration, and not limitation, and that any suitable implementation of pulse generator 303 could be used. For example, an equivalent circuit could be constructed using different gates (e.g., AND gates and inverters), or an entirely different circuit could be used (e.g., a circuit using master-slave flip-flops or the like).

The operation of pulse generator 303 will now be described in more detail in connection with FIG. 6, which shows an illustrative state diagram 600 for pulse generator 303. As described above, pulse generator 303 has two state variables, X and Y, which vary in accordance with a Gray coding scheme in order to avoid race conditions. As shown in FIG. 6, the initial state of pulse generator 303 is XY=00 (block 602). When the START input 502 (coupled to the external clock) transitions to a low voltage, the pulse generator moves to state XY=10 (block 604). Subsequently, when the START input transitions to a high voltage, the pulse generator moves to state XY=11 (block 606). Thus, the arrival of the pulse generator at state XY=11 occurs on the START input's rising edge, which occurs when the external clock to which the START input is coupled goes from a low voltage to a high voltage. Thus, the state variable Y, and hence the output signal OUT 506, transitions to a high voltage upon detection of a rising edge on the external clock signal coupled to the START input 502. From state XY=11 (block 606), pulse generator 303 moves directly to state XY=01 (block 608), since the requirement for this transition is “don't-care”. When the RESET output from comparator 302 goes high as a result of V_{FDBK} exceeding V_{REF}, pulse generator 303 returns to its initial state of XY=00 (block 602).

FIG. 7 is an illustration of a method for using a voltage regulator such as that shown in FIG. 1 or 3 to provide an output voltage that is a substantially constant function of an input reference voltage. Referring to FIG. 7, the duty cycle of the voltage regulator's output waveform is monitored using the voltage regulator's feedback loop (block 702). The duty cycle is then adjusted by the feedback loop such that the DC value of the output waveform tracks the reference voltage (block 704).

It should be appreciated that FIGS. 1-7 are provided for purposes of illustration, and not limitation, and that a number of modifications could be made without departing from the principles that are illustrated therein. For example, it should be appreciated that the various components (e.g., R₁, R₂, V_{REF}, CLK, etc.) shown in FIGS. 1 and 3 can be selected and implemented in any suitable manner for the application at hand, and that a number of other modifications could be made to the illustrative implementations shown and described in connection with FIGS. 1 and 3. For example, in some embodiments, additional components could be added to the systems shown in FIGS. 1 and 3, and in other embodiments certain components could be removed or combined with other components. For example, in one embodiment, a load compensator could be coupled between the reference voltage input and the output load resistance, such as is described in commonly assigned, co-pending application Ser. No. ______, entitled “Voltage Regulator Load Compensator” (Attorney Docket No. INTCPO26), by Mel Bazes and concurrently filed herewith. Similarly, although FIG. 1 shows the feedback voltage and the reference voltage coupled to the positive and negative inputs, respectively, of a comparator, it will be appreciated that, for example, this polarity could be reversed, and a non-inverting output stage could be used instead of the inverting output stage 106 shown in FIG. 1. In other embodiments, logic gates and circuit elements such as NAND gates, AND gates, capacitors, and inductors can be replaced by their duals and/or equivalents (e.g., replacing an AND gate with a NAND gate followed by an inverter). Moreover, it should be appreciated that the voltage regulators shown in FIGS. 1 and 3 can be designed and packaged in any suitable manner. For example, in some embodiments a voltage regulator may be implemented entirely on an integrated circuit chip, while in other embodiments some or all of the voltage regulator may be implemented using discrete components, such as a separate filter (e.g., inductor) 118, capacitor 122, diode 124, output stage 106, or the like.

Thus, embodiments of the systems and methods described herein can be used for a wide variety of purposes and in a wide variety of applications. For example, embodiments of the switching voltage regulators described herein can be used to provide a stable output voltage for microprocessors, Ethernet controllers, or any other suitable chip or system (e.g., a CMOS very large scale integrated (VLSI) device). For example, embodiments of the systems and methods described herein can be used to provide voltage regulation for laptop computers and other battery-operated applications, or other applications for which relatively low heat generation and relatively low power consumption are desirable.

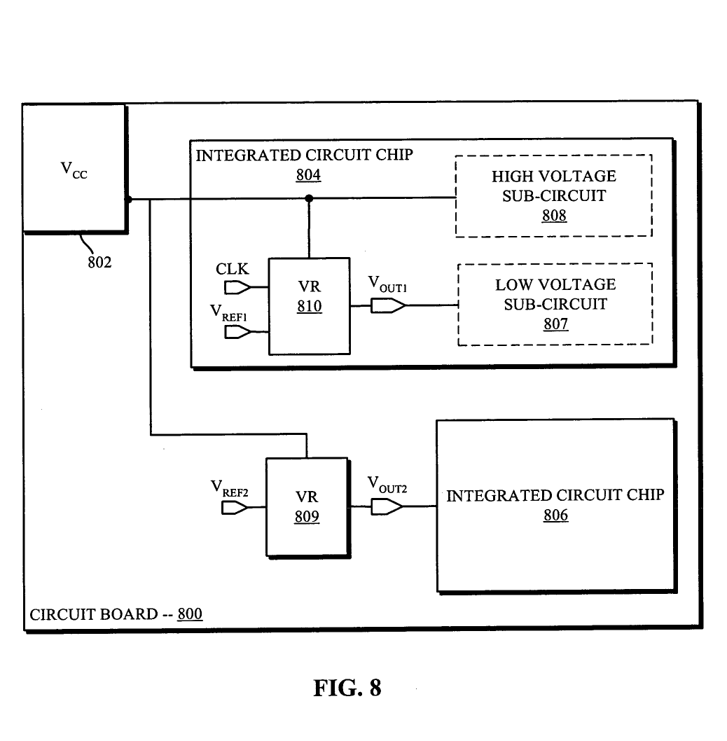

An example of one such system is shown in FIG. 8. Referring to FIG. 8, a circuit board 800 is shown that includes a power supply input, V_{CC} 802, and two integrated circuit (IC) chips 804 and 806. Chip 804 includes a voltage regulator (VR) 810, such as voltage regulator 300 in FIG. 3, that is coupled to V_{CC} 802 and generates a supply voltage V_{OUT1} that is lower than V_{CC} for use by low voltage sub-circuit 807. Chip 804 also includes a high voltage sub-circuit 808 that uses V_{CC} as its supply voltage.

Circuit board 800 further includes a voltage regulator (VR) 809, such as that shown in FIG. 1 or 3, that is manufactured as an independent integrated circuit chip or board. Voltage regulator 809 is also coupled to V_{CC}, and generates an output supply voltage V_{OUT2} that is used by integrated circuit chip 806.

By using supply voltages V_{OUT1} and V_{OUT2} that are lower than V_{CC}, circuit 807 and integrated circuit chip 806 may consume less power than if V_{CC} were used as the supply voltage.

It should be appreciated that FIG. 8 is provided for purposes of illustration, and not limitation, and that a number of variations can be made to the systems and methods described in connection therewith. For example, it should be appreciated that the elements shown in FIG. 8 can be implemented in any suitable manner, and that a number of modifications could be made to the illustrative implementations shown in FIG. 8. For example, circuit board 800 may be used in various systems, such as computer systems or telecommunications systems, and chips 804 and 806 may include digital circuits and/or analog circuits. Similarly, it should be appreciated that in some embodiments voltage regulator 810 may be manufactured on the same die as circuit 807, while in other embodiments voltage regulator 810 and circuit 807 may be manufactured on different dies but packaged in the same package. In yet another example, there may be more than one voltage regulator generating various supply voltages in the same chip, or a single voltage regulator may span a number of chips. In some embodiments V_{CC} 802 may be powered by an external power supply, while in other embodiments, V_{CC} 802 may be powered by an on-board power supply.

Thus, while several embodiments are described and illustrated herein, it will be appreciated that they are merely illustrative. For example, without limitation, while various embodiments of a switching voltage regulator have been shown in the context of semiconductor implementations, it will be appreciated that these switching voltage regulators could be modeled in a computer simulation system as well. Accordingly, other embodiments are within the scope of the following claims.

What is claimed is:

1. A voltage regulator comprising:
a first input operable to be coupled to a supply voltage;
a second input operable to be coupled to a reference voltage;
an output operable to provide an output voltage that is a substantially constant function of the reference voltage;
an output stage operable to provide a pulsed output voltage;
a filter, the filter having a first terminal coupled to the output stage and a second terminal coupled to an output load resistance; and
a feedback loop coupled between the output stage and an input of a comparator.

2. The voltage regulator of claim 1, in which the output voltage is less than the supply voltage.

3. The voltage regulator of claim 1, in which the second input is coupled to a second input of the comparator.

4. The voltage regulator of claim 1, in which the feedback loop comprises a low pass filter and a voltage divider circuit.

5. The voltage regulator of claim 1, in which the output stage comprises two transistors coupled together between the supply voltage and a common reference potential, and in which the pulsed output voltage is provided at a point at which the two transistors are coupled.

6. The voltage regulator of claim 1, further comprising a Schottky diode coupled between the output stage and a common reference potential.

7. The voltage regulator of claim 1, further comprising a pulse generator, an input of the pulse generator being coupled to an output of the comparator, another input of the pulse generator being coupled to a clock, and an output of the pulse generator being coupled to an input of the output stage.

8. The voltage regulator of claim 7, further comprising a pre-driver circuit, the pre-driver circuit being operable to drive the output stage, the output of the pulse generator being coupled to an input of the pre-driver circuit.

9. The voltage regulator of claim 1, in which the filter comprises an inductor.

10. A voltage regulator operable to generate a first supply voltage from a second supply voltage, the voltage regulator including:
a comparator having a first comparator input, a second comparator input, and a comparator output, the comparator being operable to amplify a voltage difference between the first comparator input and the second comparator input, wherein the first comparator input is configured to be coupled to a reference voltage, and the second comparator input is configured to be coupled to a feedback voltage;
an output stage, the output stage being configured to be coupled to the second supply voltage, the output stage having an input that is configured to be directly or indirectly driven by the comparator output, the output stage having an output stage output that is operable to provide a pulsed output voltage from which the feedback voltage can be derived;
a filter coupled between the output stage output and an output load resistance; and
a feedback loop, the feedback loop being coupled between the output stage output and the second comparator input.

11. The system of claim 10, in which the output stage comprises a PMOS transistor and an NMOS transistor configured to be coupled between the second supply voltage and a common reference potential.

12. The system of claim 10, further comprising a diode coupled between the output stage output and a common reference potential.

13. The system of claim 10, further comprising a capacitor coupled between the second input of the comparator and a common reference potential.

14. The system of claim 10, further comprising a low pass filter coupled to the output stage output.

15. The system of claim 10, further comprising:
a pulse generator, an input of the pulse generator being coupled to the comparator output, another input of the pulse generator being coupled to a clock, and an output of the pulse generator being operable to drive an input of the output stage.

16. The system of claim 15, in which the pulse generator comprises an asynchronous finite state machine.

17. A method comprising:
controlling an output voltage to track a reference voltage, including:
using a feedback loop to monitor an output duty cycle and to maintain an output voltage that is substantially constant relative to the reference voltage.

18. The method of claim 17, in which using a feedback loop to monitor an output duty cycle includes using a comparator to amplify a difference between the reference voltage and a direct current component of the output voltage.

19. The method of claim 18, further comprising:
providing a supply voltage to an output stage, the supply voltage having a voltage level different from the reference voltage; and
generating the output voltage from the supply voltage.

20. The method of claim 17, further comprising:
controlling, using a pulse generator, a frequency of an alternating current component of the output voltage.

21. A voltage regulator operable to control an output voltage to track a reference voltage, the voltage regulator including a feedback loop operable to monitor an output duty cycle and to maintain the output voltage as a substantially constant function of the reference voltage.

22. The voltage regulator of claim 21, in which the feedback loop includes a comparator operable to amplify a difference between the reference voltage and a direct current component of the output voltage.

23. The voltage regulator of claim 22, further comprising:
a supply voltage input, the supply voltage input being operable to provide a supply voltage having a different voltage level from the reference voltage, the voltage regulator being operable to generate the output voltage from the supply voltage.

24. The voltage regulator of claim 21, further comprising a pulse generator, the pulse generator being operable to control a frequency of an alternating current component of the output voltage.

25. A system comprising:
a circuit board;
an integrated circuit chip comprising:
a first circuit designed to operate using a first supply voltage;
a second circuit designed to operate using a second supply voltage;
a voltage regulator operable to generate the second supply voltage from the first supply voltage, the voltage regulator comprising:
a comparator having a first comparator input and a second comparator input, the comparator being operable to amplify a voltage difference between the first comparator input and the second comparator input, wherein the first comparator input is coupled to a reference voltage, and the second comparator input is coupled to a feedback voltage;
an output stage, the output stage being coupled to the first supply voltage, the output stage having an output stage output operable to supply a pulsed output voltage from which the feedback voltage can be derived;
a filter coupled between the output stage output and the second circuit; and
a feedback loop, the feedback loop being coupled between the output stage output and the second comparator input.

26. The system of claim 25, in which the voltage regulator comprises a pulse generator, an input of the pulse generator being coupled to an output of the comparator, another input of the pulse generator being coupled to a clock, and an output of the pulse generator being operable to drive an input of the output stage.

27. The system of claim 25, further comprising:
a second integrated circuit chip, the second integrated circuit chip comprising a third circuit designed to operate using a third supply voltage; and
a second voltage regulator operable to generate the third supply voltage from the first supply voltage.

28. The system of claim 27, in which the second voltage regulator comprises an integrated circuit chip.
